(19) United States
(12) Patent Application Publication
(10) Pub. No.: US 2026/0174534 A1
(43) Pub. Date: Jun. 25, 2026

(54) WATER FLOSSER WITH ROTATING MANIFOLDS

(71) Applicant: Stuart BERGER, Scarsdale, NY (US)

(72) Inventor: Stuart BERGER, Scarsdale, NY (US)

(21) Appl. No.: 18/833,851

(22) PCT Filed: Oct. 16, 2023
(86) PCT No.: PCT/US2023/035220

§ 371 Date: Jul. 26, 2024

Related U.S. Application Data
(60) Provisional application No. 63/542,555, filed on Oct. 5, 2023.

(51) Int. Cl. A61C 17/02; A61C 17/028

(52) U.S. Cl. CPC A61C 17/0202; A61C 17/028

(57) ABSTRACT

A flossing assembly includes a housing defining an outlet. A pump assembly is configured to emit fluid through the outlet. A leg component is connected to the outlet and terminates at a connector defining a passage along an axis. The leg component receives fluid from the outlet and transmits the fluid to an orifice in the passage. A first manifold and a second manifold each have a U-shape and include a base and a pair of wings. Each of the manifolds has a cylinder extending from the base, with the cylinders in alignment with one another and received by the passage. At least one of the cylinders defines an opening for receiving fluid from the orifice and transmitting the fluid to the wings. Each of the wings defines a spray orifice for emitting fluid. The first and second manifolds are rotatable about the axis relative to the connector.

### CROSS-REFERENCE TO RELATED APPLICATIONS

The present disclosure claims priority to and is a national phase application of PCT Application PCT/US 2023/035220, filed Oct. 16, 2023, which claims the benefit and priority to U.S. Provisional Patent Application Ser. No. 63/542,555, filed Oct. 5, 2023, the entire disclosure of which is incorporated herein by reference.

### BACKGROUND

### 1. Technical Field

The present disclosure relates to dental hygiene devices. More particularly, the present disclosure relates to a water flosser with a rotatable manifold assembly for permitting a user to simultaneously clean top and bottom teeth in a comfortable manner.

### 2. Related Art

This section provides background information related to the present disclosure which is not necessarily prior art.

Various devices have been developed over the years to make dental hygiene more effective and simple to manage. Examples include improvements to tooth brushes, dental floss and water flossers. There remains a need for further improvements to dental hygiene devices.

### SUMMARY

According to an aspect of the disclosure, a flossing assembly includes a housing defining an outlet. A pump assembly is contained in the pump segment and configured to draw a fluid from the housing and emit the fluid through the outlet. A manifold assembly includes a leg component connected to the outlet and terminating at a connector defining a passage. The passage extends along an axis. The leg component defines a hollow for receiving fluid from the outlet and terminates at an orifice in the passage of the connector. The manifold assembly further includes a first manifold and a second manifold each having a U-shape including a base and a pair of wings each extending from the base in spaced relationship with one another. Each of the first and second manifolds includes a cylinder extending from the base opposite the wings, with the cylinders of the first and second manifolds extending toward one another in alignment with one another along the axis and each received by the passage of the connector of the leg component. At least one of the cylinders of the first and second manifolds defines an opening for receiving fluid from the orifice of the connector and transmitting the fluid to the wings. Each of the wings defines a spray orifice for emitting fluid received from the orifice of the connector at a user's teeth. The first and second manifolds are rotatable about the axis relative to the connector of the manifold assembly.

The ability of the first and second manifolds to rotate while emitting fluid allows the flossing assembly to simply and comfortably be moved within a user's mouth.

### BRIEF DESCRIPTION OF THE DRAWINGS

These and other advantages of the present disclosure will be more readily understood by reference to the following description in combination with the accompanying drawings wherein:

FIG. 1 is a front, perspective view of a water flosser assembly;

FIG. 2 is a rear, perspective view of the water flosser assembly;

FIG. 3 is a top, perspective view of a manifold assembly of the water flosser assembly;

FIG. 4 is a bottom, perspective view of the manifold assembly;

FIG. 5 is a top perspective view of a connector of the manifold assembly coupled to a housing of the water flosser assembly;

FIG. 6 is a bottom view of a second manifold of the manifold assembly;

FIG. 7 is a bottom view of a first manifold of the manifold assembly;

FIG. 8 is a front view of a pump assembly of the water flosser assembly, with a front shell of a housing removed;

FIG. 9 is a side, cutaway view of the pump assembly;

FIG. 10 is a side view of the pump assembly with the front shell of the housing removed;

FIG. 11 is a rear cutaway view of the pump assembly;

FIG. 12 is a side, cutaway view of a flow housing of the pump assembly;

FIG. 13 is a front, cutaway view of the flow housing of the pump assembly;

FIG. 14 is a bottom, perspective view of a seal of the pump assembly; and

FIG. 15 is a top, perspective view of the seal of the pump assembly.

### DETAILED DESCRIPTION

Example embodiments will now be described more fully with reference to the accompanying drawings. In general, the subject embodiments are directed to a water flosser assembly 10. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

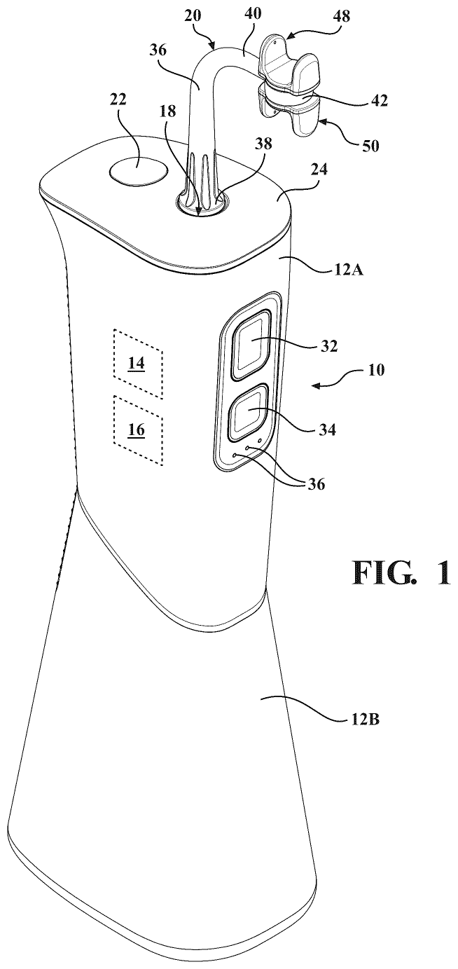

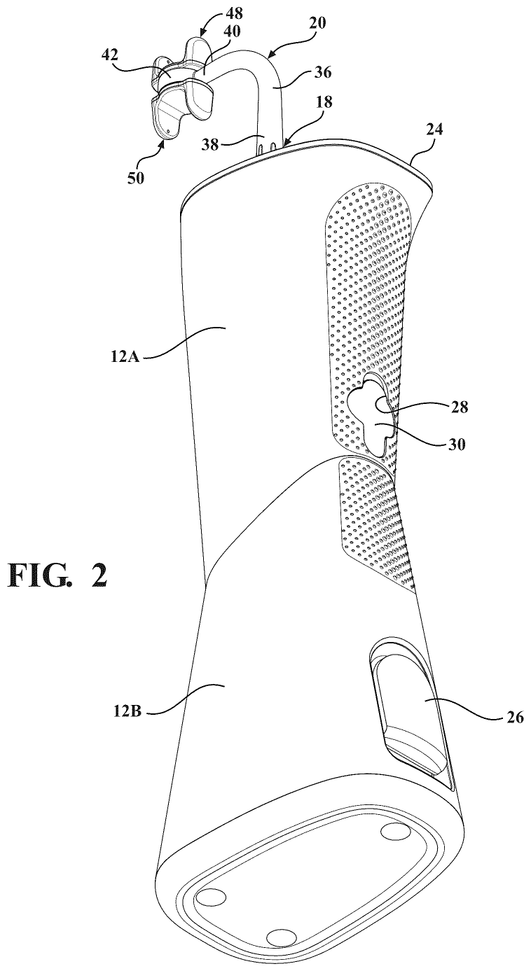

With reference to FIGS. 1 and 2, the water flosser assembly 10 includes a housing 12A, 12B that is comprised of a pump segment 12A and a reservoir segment 12B, with the pump segment 12A positioned above the reservoir segment 12B.

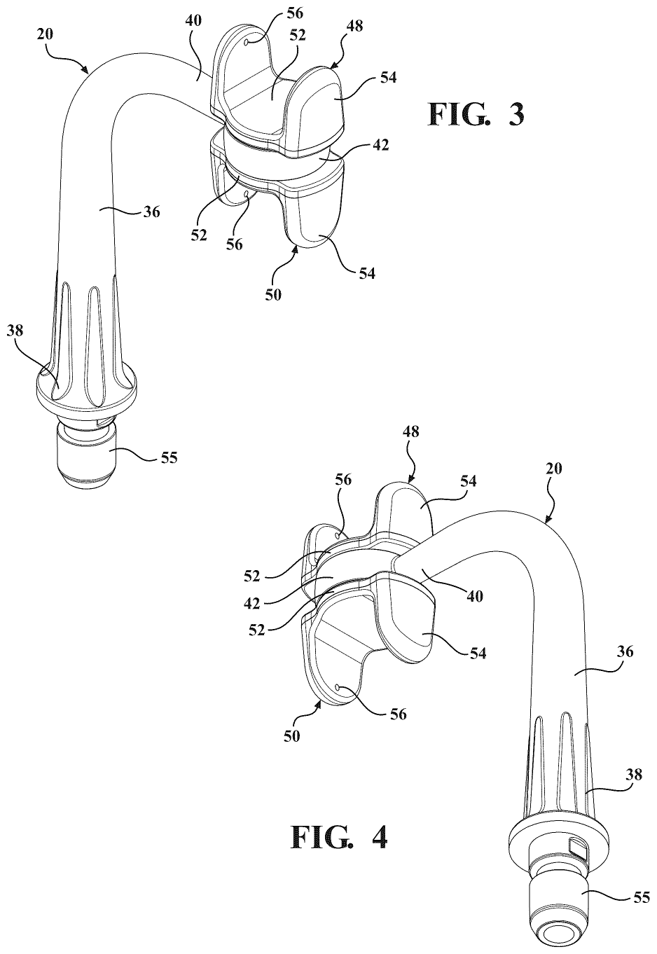

The pump segment 12A contains a pump assembly 14 and associated power source 16 (schematically shown in FIG. 1) for powering the water flosser 10. The pump assembly 14 is connected to a connection outlet 18 at the top of the pump compartment 12A for emitting water through the connection outlet 18. A manifold assembly 20 is connected to the connection outlet 18 for emitting the water from the pump assembly 14 through the connection outlet 18 and through the manifold assembly 20. A button 22 is located at the top of the housing 12A, 12B for selectively locking and unlocking the manifold assembly 20 in place. This permits different manifold assemblies 20 to be connected to the housing 12A, 12B, e.g., for different users. As shown in FIGS. 3 and 4, the manifold assembly 20 includes a mounting protrusion 55 that is configured to be engaged by a spring-loaded tab (not shown) when the manifold assembly 20 is inserted into the connection outlet 18. The button 22 is configured to move the tag to couple and disengage the mounting protrusion 55.

As best shown in FIG. 2, the reservoir segment 12B of the housing 12A, 12B includes an inlet tab 26 that is moveable between an open position in which an opening into a basin in the reservoir segment is revealed to permit the basin to be filled with a fluid such as water, and a closed position in which the opening is closed to seal the opening into the basin. It should be appreciated that the term “water” as used herein may encompass other cleaning fluids, e.g., a medicated rinse.

A charging port 28 is defined along the pump segment 12A for receiving a power cable to charge the power source 16. A cover 30 removeably covers the charging port 28 to permit the charging port 28 to be sealed when not in use.

As best shown in FIG. 1, a power button 32 is located along a front of the pump segment 12A of the housing 12A, 12B for turning on and off the pump assembly 14, and a mode button 34 is located adjacent to the power button 32 for allowing an operator to select different operational characteristics of the pump assembly 14. A plurality of indicator lights 36 (e.g., LEDs) are located adjacent to the mode button 34 for indicating the operational state to the operator. It should be appreciated that the pump assembly 14 may be configured to pulse the outflow of water at different frequencies and/or different pressures.

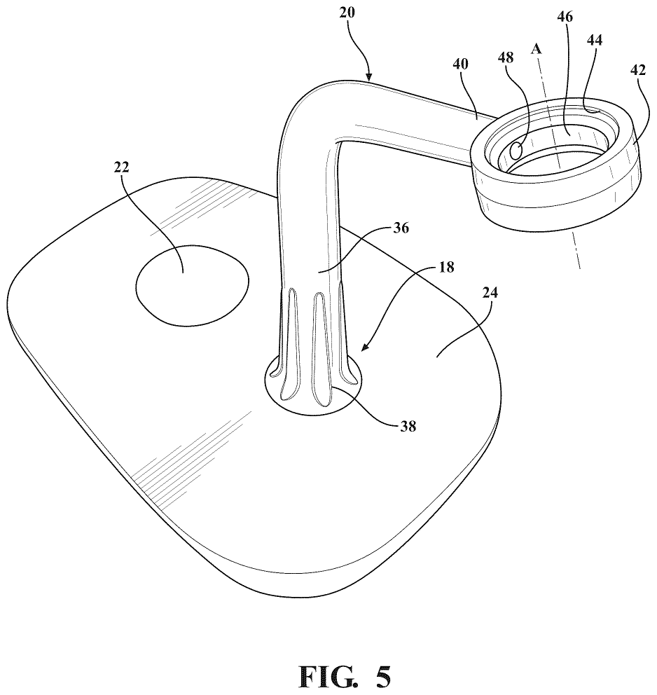

As best shown in FIGS. 3-4, the manifold assembly 20 has a generally L-shaped leg component 36. The leg component 36 defines a hollow that extends along a length of the leg component 36 for passing fluid through the leg component 36. The leg component 36 includes a first end region 38 which includes the mounting protrusion 55 for being removeably attached to the connection outlet 18 at the pump segment 12A (as discussed above), and a second end region 40 through which fluid is emitted. As best shown in FIG. 5, a ring-shaped connecter 42 is located at the second end region 40. The connector 42 defines a circular bore 44 that is disposed about an axis A. A ring-shaped seat 46 is located inside the bore 44 in spaced relationship with axial ends of the connector 42. The seat 46 defines an orifice 48 which is fluidly connected to the hollow of the leg component 36 for passing fluid received from the connection outlet 18.

As best shown in FIG. 3, the manifold assembly 20 also includes a first manifold 48 and a second manifold 50 positioned on opposite sides of the connector 42 as one another. Each of the first and second manifolds 48, 50 generally has a U-shape with a base region 52 and a pair of wings 54 extending perpendicularly from the base region 52 in parallel relationship with one another for surrounding a user's teeth during use. The base regions 52 are arranged such that bottom surfaces in the base regions 52 face one another such that together the two manifolds 48, 50 together generally have an H-shape (shown in FIGS. 3-4). During use, each of the manifolds 48, 50 is configured to surround the teeth of a respective top and bottom row of teeth in the user's mouth such that both rows of teeth are surrounded by manifolds 48, 50 at the same time to permit flossing of both rows of teeth at the same time. Each of the wings 54 are configured to overlie one of the front and rear surfaces of the user's teeth while the base region 52 is configured to overlie the top/bottom surfaces of the user's teeth.

Each of the wings 54 is hollow and defines an orifice 56 along a face of the wing 54 for emitting the fluid out of the wing 54 at the user's teeth to create the flossing effect. The base region 52 defines at least one opening (not shown) extending into each of the wings 54 for receiving water from the orifice 48 of the connector 42 and passing the fluid into the hollow of the wing 54.

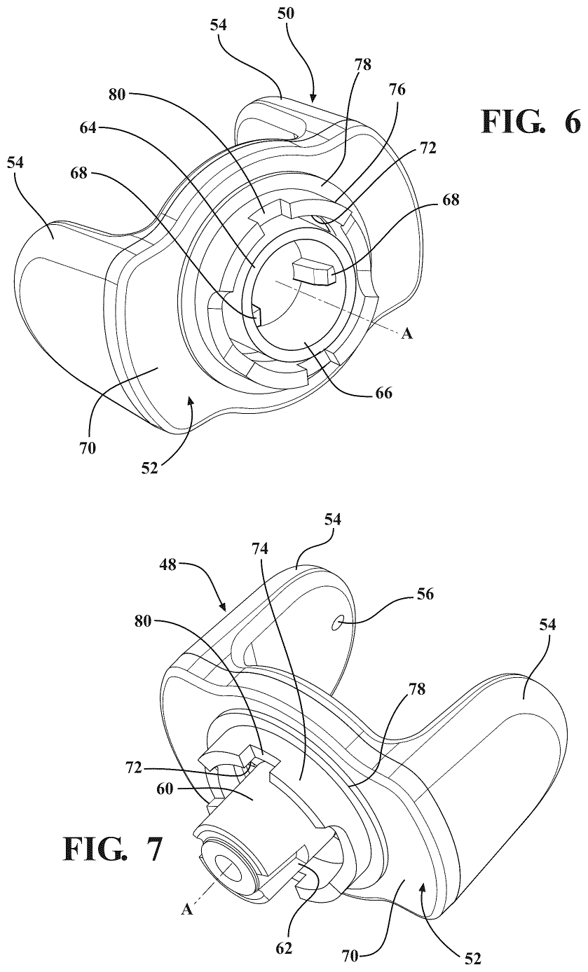

As shown in FIG. 7, an inner post 60 extends from the base region 52 of the first manifold 48 along axis A and terminates at an end. The inner post 60 defines a pair of radially inwardly extending notches 62 extending axially from the end toward the base region 52. As shown in FIG. 6, an outer post 64 extends from the base region 52 of the second manifold 50 along the axis A and defines a channel 66 along the axis A which receives the inner post 58 such that the inner post 60 is rotatable relative to the outer post 64. The outer post 64 defines a pair of radially-inwardly extending tabs 68 on diametrically opposite sides of the outer post 64 inside the channel 66. Each of the tabs 68 are received in one of the notches 62 of the inner post 60 in order to limit rotation of the inner post 60 relative to the outer post 64, and thus limit rotation of the manifolds 48, 50 relative to one another. More particularly, a circumferential width of each of the notches 62 is wider than a circumferential width of each of the tabs 68 to limit rotation to a predetermined extent. A degree of rotation of the first and second manifolds 48, 50 relative to each other provides a more comfortable flossing experience for the user. Any number of tabs and notches could be used based on specific needs. It should be appreciated that an interference fit may be provided between the inner and outer posts 60, 64 to inhibit the manifolds 48, 50 from moving axially relative to one another. In an alternate arrangement, the notches 62 and tabs 68 may have the same width to inhibit rotation of the first and second manifolds 48, 50 relative to one another.

As best shown in FIGS. 6-7, a pair of plates 70 are each located at one of the base regions 52 of the manifolds 48, 50. Each of the plates 70 defines a central opening 72 for permitting fluid to flow to the wings 54. As shown in FIG. 6, a first outer cylinder 74 extends from the plate 70 of the first manifold 48 and surrounds the inner post 60 on the first manifold 48, and a second outer cylinder 76 extends from the plate of the second manifold 50 and surrounds the outer post 64 on the second manifold 50. The first and second outer cylinders 74, 76 have the same diameter as one another such that they axially abut one another. The first and second outer cylinders 74, 76 are rotatably received inside of the seat 46 of the connector 42, thus permitting free rotation of the manifold assembly 20 about the axis during flossing by a user. As shown in FIG. 5, a seal 78, e.g., an o-ring 78, or other suitable seal surrounds each of the outer cylinders 74, 76 for sealing between the seat 46 of the connector 42 and each of the outer cylinders 74,76. A plurality of notches 80 are defined at ends of each of the outer cylinders 74, 76 to permit water to flow from the orifice 48 inside the connector 72 to the wings 54 of the manifolds 48, 50. The notches 80 of the first outer cylinder 74 are aligned with the notches 80 of the second outer cylinder 76.

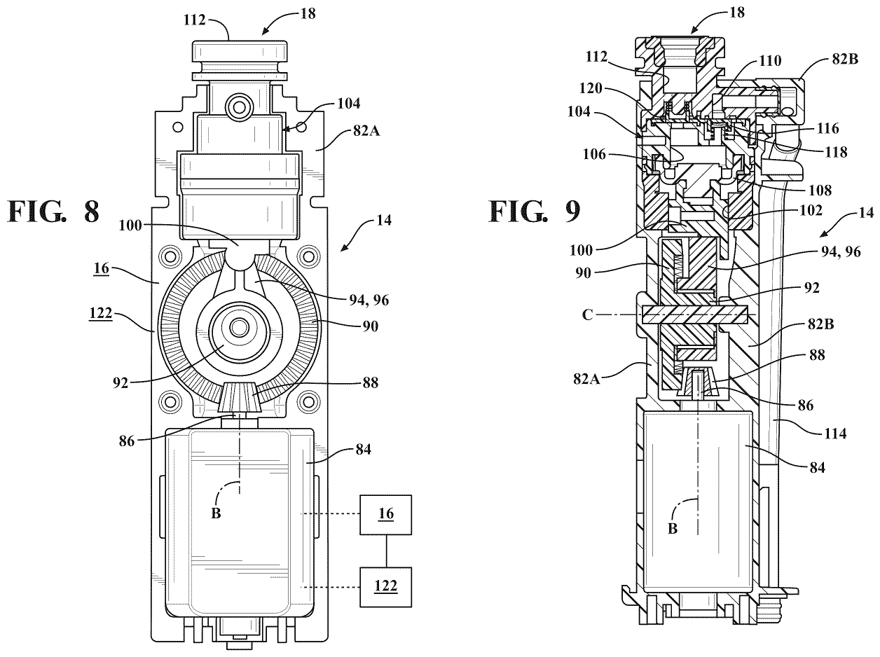

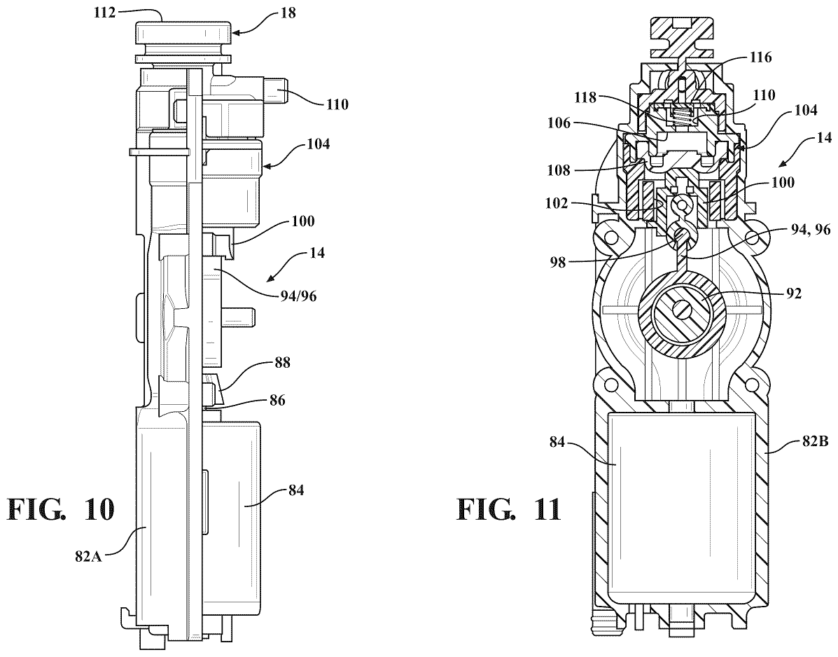

An embodiment of the pump assembly 14 is illustrated in FIGS. 8-12. The pump assembly 14 includes a housing 82A, 82B comprised of rear shell 82A and a front shell 82B for sealingly containing components of the pump assembly 14 in a compartment of the housing 82A, 82B.

A motor 84 is contained in the compartment of the housing 82A, 82B. As best shown in FIG. 8, the motor 84 has a rotary output 86 that is rotatable about a second, motor axis B. Various types of electric motors may be used.

A first gear 88 such as a pinion gear 88 is connected to the output 86 of the motor 84 to rotate with the output 86 of the motor 84. A second gear 90 such as a crown gear 90 is positioned in the compartment and is rotatable about a third, crown axis C that extends perpendicular to the motor axis B. An eccentric coupler 92 is fixedly connected to the crown gear 90 along the crown axis C at a point on the eccentric coupler 92 that is off-center. A connecting rod 94 is rotatably fitted about the eccentric coupler 92 and includes an arm 96 that terminates at a ball 98. A piston 100 is pivotably connected to the ball 98 and is slideable within a cylinder 102 such that rotation of the crown gear 90 and off-axis eccentric coupler 92 causes the arm 96 of the connecting rod 94 and piston 100 to move up and down in a vertical direction within the cylinder 102.

A flow housing 104 is positioned in the compartment of the housing 82A, 82B above the cylinder 102. The flow housing 104 includes a fluid chamber 106 for receiving and expelling fluid from the reservoir segment 12B. A seal 108 sealingly separates the fluid chamber 106 of the flow housing 104 from the cylinder 102 in which the piston 100 is located. The seal 108 is connected to the piston 100 for moving in the vertical direction with the piston 100.

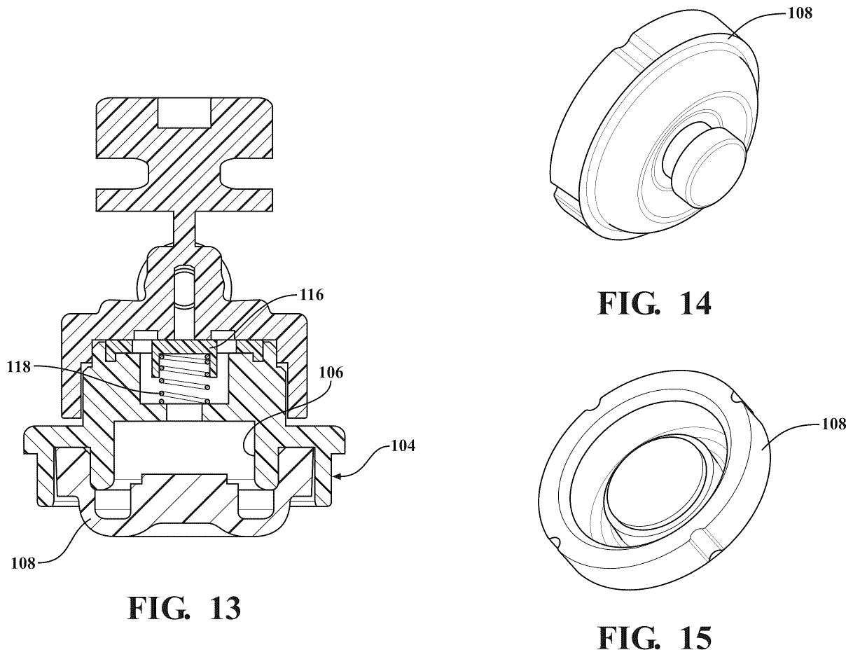

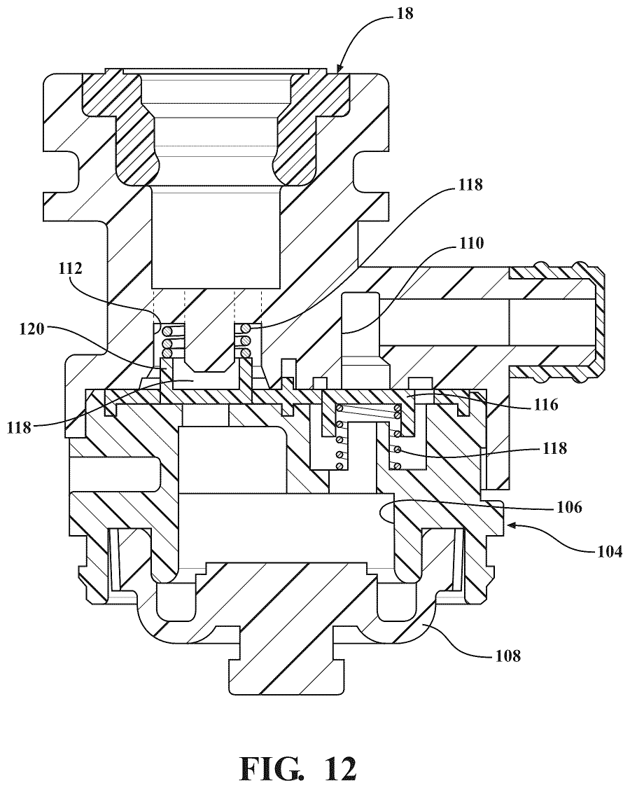

As best shown in FIGS. 9 and 12, the flow housing 104 further defines an inlet passage 110 and an outlet passage 112 that each extend into the fluid chamber 106. As shown in FIG. 9, the inlet passage 110 is connected to a hose 114 which extends into the reservoir segment 12B for receiving fluid from inside the reservoir segment 12B. An inlet valve 116 is positioned along the inlet passage 110 for opening and sealing the inlet passage 110. A biasing mechanism 118 like a spring 118 biases the inlet valve 116 into a sealing position. An outlet valve 120 is positioned along the outlet passage 112 for opening and sealing the outlet passage 112. A biasing mechanism 118 like a spring 118 biases the outlet valve 120 into the sealing position. The inlet and outlet valves 116, 120 are biased in their closed positions in opposite directions from one another such that pressure and suction effects in the fluid chamber 106 cause opposite closing and opening effects of the inlet and outlet passages 110, 112.

More particularly, during operation, a down stroke of the piston 100 and valve 108 creates a suction effect in the fluid chamber 106 of the flow housing 104 which moves the inlet valve 116 against its associated biasing mechanism 118 to permit fluid to flow from the reservoir segment 12B into the fluid chamber 106. In the meantime, the suction effect further biases the outlet valve 120 into its sealing position to prevent fluids (e.g., air) from entering the fluid chamber 106 from the outlet passage 112.

On the other hand, an up stroke of the piston 100 pressurizes the fluid chamber 106 of the flow housing 104, which further biases the inlet valve 116 into its sealing position to prevent fluid from the reservoir segment 12B from entering the fluid chamber 106. In the meantime, the pressure in the fluid chamber 106 moves the outlet valve 120 against its associated biasing mechanism 118 to permit fluid to flow from the fluid chamber 106 out of the outlet passage 112 to the manifold assembly 20 and to the user's mouth.

A circuit board 122 (schematically shown in FIG. 8) is connected to the pump assembly 14 and electrically connected to the motor 84 for controlling operation of the motor 84. The circuit board 122 is electrically connected to the power button 32 and mode button 34 for permitting the operator to adjust operational characteristics of the pump assembly 14. For example, a speed of the motor 84 may be adjusted to adjust a pressure and/or pulse frequency of the output of fluid at the manifold assembly 20.

As schematically illustrated in FIG. 8, the power source 16 is connected to the pump assembly 14 and electrically connected to the motor 84 and circuit board 122 for powering the motor 84 and circuit board 122.

Obviously, many modifications and variations of the present disclosure are possible in light of the above teachings and may be practiced otherwise than as specifically described.

What is claimed is:

1. A flossing assembly, comprising:
a housing defining a compartment and an outlet extending into the compartment;
a pump assembly contained in the compartment of the housing and configured to draw a fluid from inside the compartment and emit the fluid through the outlet;
a manifold assembly including a leg component connected to the outlet and terminating at a connector generally having a ring shape and defining a passage, the passage extending along an axis;
the leg component having a first segment coupled to the outlet of the housing, and a second segment terminating at the connector, wherein the first and second segments extend generally perpendicularly to one another;
the leg component defining a hollow for receiving fluid from the outlet of the housing and terminating at an orifice in the passage of the connector;
the manifold assembly further including a first manifold and a second manifold each including a base and a pair of wings each extending from the base in spaced relationship with one another and at an angle relative to the base, wherein the base of each of the manifolds is connected to the connector of the leg component with the manifolds extending in axially opposite directions from one another;
each of the wings defining a spray orifice for emitting fluid received from the orifice of the connector at a user's teeth; and
the first and second manifolds being rotatable about the axis relative to the connector of the manifold assembly.

2-6. (canceled)

7. The flossing assembly as set forth in claim 1, wherein the leg component is removably attachable to the housing.

8. The flossing assembly as set forth in claim 1, wherein the pump assembly includes a motor having a rotary output, wherein an eccentric coupler is coupled to the rotary output, and wherein a piston is linearly moveable in a cylinder in response to rotation of the eccentric coupler to create a suction and pressure effect to emit the fluid out of the manifold assembly.

9. The flossing assembly as set forth in claim 8, wherein a flow housing is located in the pump segment of the housing above the cylinder, wherein the flow housing has a fluid chamber, an inlet passage for receiving fluid from the reservoir segment into the fluid chamber, and an outlet passage for emitting the fluid from the fluid chamber out of the outlet of the housing to the manifold segment in response to movement of the piston.

10. The flossing assembly as set forth in claim 9, wherein a seal sealingly separates the fluid chamber from the cylinder, the seal being connected to the piston for moving with the piston to create the suction and pressure effect in the fluid chamber.

11. The flossing assembly as set forth in claim 10 wherein an inlet valve is positioned along the inlet passage for opening and sealing the inlet passage, wherein the inlet valve is biased in a closed position closing the inlet passage, wherein an outlet valve is positioned along the outlet passage for opening and sealing the outlet passage, wherein the outlet valve is biased in a closed position closing the outlet passage such that a down stroke of the piston creates the suction effect in the fluid chamber which moves the inlet valve into its open position to permit fluid to flow from the reservoir segment into the fluid chamber and biases the outlet valve into the sealing position to prevent fluid from escaping the fluid chamber through the outlet passage, and an up stroke of the piston creates the pressure effect in the fluid chamber to bias the inlet valve into the sealing position to prevent fluid from entering fluid chamber through the inlet passage and to move the outlet valve into its open position to permit fluid to flow from the fluid chamber out of the outlet passage to the manifold assembly.

12. The flossing assembly as set forth in claim 11, wherein the inlet valve and outlet valve are biased toward their closed positions in opposite directions from one another.

13. The flossing assembly as set forth in claim 12, wherein each of the inlet and outlet valves are piston shaped, and wherein a pair of biasing mechanism each bias one of the inlet and outlet valves in their closed positions.

14. The flossing assembly as set forth in claim 13, wherein the biasing mechanisms are springs.

15. The flossing assembly as set forth in claim 8, wherein a first gear is connected to the output of the motor for rotating with the output about a motor axis, and wherein a second gear is meshed with the first gear and rotatable about third axis which is perpendicular to the motor axis, and wherein the eccentric coupler is rotationally fixed to the second gear at a location spaced from the second axis to couple the eccentric coupler to the rotary output of the motor.

16. A flossing assembly, comprising:
an elongated housing having a reservoir segment and a pump segment, wherein the reservoir segment is configured to hold a fluid, and wherein the pump segment is positioned above the reservoir segment;
an outlet extending into housing along the pump segment;
a pump assembly contained in the pump segment-of the housing and configured to draw a fluid from the reservoir segment and emit the fluid through the outlet;
a manifold assembly including a leg component connected to the outlet of the housing and terminating at a connector generally having a ring shape and defining a passage;
the leg component having a first segment and a second segment extending generally perpendicularly to one another, wherein the first segment is coupled to the outlet of the housing, and the second segment terminates at the connector;
the leg component defining a hollow for receiving fluid from the outlet of the housing and terminating at an orifice in the passage of the connector;
the manifold assembly further including a first manifold and a second manifold each including a base and a pair of wings each extending from the base in spaced relationship with one another and at an angle relative to the base, wherein the base of each of the manifolds is connected to the connector of the leg component with the manifolds extending in axially opposite directions from one another;
each of the wings defining a spray orifice for emitting fluid received from the orifice of the connector at a user's teeth; and
the first and second manifolds being rotatable about the axis relative to the connector of the manifold assembly.

17. The flossing assembly as set forth in claim 16, wherein the leg component is removably attachable to the housing.

18. The flossing assembly as set forth in claim 16, wherein the pump assembly includes a motor having a rotary output, wherein an eccentric coupler is coupled to the rotary output, and wherein a piston is linearly moveable in a cylinder in response to rotation of the eccentric coupler to create a suction and pressure effect to emit the fluid out of the manifold assembly.

19. The flossing assembly as set forth in claim 18, wherein a flow housing is located in the pump segment of the housing above the cylinder, wherein the flow housing has a fluid chamber, an inlet passage for receiving fluid from the reservoir segment into the fluid chamber, and an outlet passage for emitting the fluid from the fluid chamber out of the outlet of the housing to the manifold segment in response to movement of the piston.

20. The flossing assembly as set forth in claim 19, wherein a seal sealingly separates the fluid chamber from the cylinder, the seal being connected to the piston for moving with the piston to create the suction and pressure effect in the fluid chamber.
